(19) United States
(12) Patent Application Publication
(10) Pub. No.: US 2016/0157441 A1
(43) Pub. Date: Jun. 9, 2016

(54) FRUIT AND VEGETABLE CAGE

(71) Applicant: Sabre ESLER, Atlanta, GA (US)

(72) Inventor: Sabre ESLER, Atlanta, GA (US)

(21) Appl. No.: 14/959,966

(22) Filed: Dec. 4, 2015

Related U.S. Application Data
(60) Provisional application No. 62/123,965, filed on Dec. 5, 2014.

(51) Int. Cl. A01G 13/10; A01G 1/00

(52) U.S. Cl. CPC A01G 13/10; A01G 1/001

(57) ABSTRACT

A cage for a piece of produce is formed from a metal mesh to prevent pests such as birds, rodents, and other small animals from reaching the piece of produce. The cage may be positioned about the piece of produce while still on the plant from which it is growing. The cage may have an opening to allow the stem of the piece of produce to pass therethrough. The cage may have a latch to hold the cage closed. The cage may include two or more pieces of metal mesh which may be hinged together.

### CROSS-REFERENCE TO RELATED APPLICATIONS

This application is a nonprovisional application which claims priority from U.S. provisional application No. 62/123,965, filed Dec. 5, 2014.

### TECHNICAL FIELD/FIELD OF THE DISCLOSURE

The present disclosure relates generally to agricultural devices, and specifically to pest control devices for agriculture.

### BACKGROUND OF THE DISCLOSURE

When growing fruits or vegetables, the produce may be exposed to the surrounding environment. This exposure may be beneficial to the produce during its maturation. However, pests such as birds, rodents, and other small animals, may be able to access and consume the produce before it is matured.

### SUMMARY

The present disclosure provides for a cage for a piece of produce. The cage may include a metal mesh. The metal mesh may have a shape adapted to fit around the piece of produce. The metal mesh may have a first side edge, a second side edge, and a top edge. The cage may include a latch coupled to the first side edge and selectively coupleable to the second side edge.

The present disclosure also provides for a method. The method may include providing a cage for a piece of produce. The cage may include a metal mesh. The metal mesh may have a shape adapted to fit around the piece of produce. The metal mesh may have a first side edge, a second side edge, and a top edge. The cage may include a latch coupled to the first side edge and selectively coupleable to the second side edge. The method may further include positioning the metal mesh about the piece of produce, pressing the first and second side edges together such that they meet or overlap, and engaging the latch with the second side edge

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a plant and piece of produce having a cage consistent with at least one embodiment of the present disclosure.

FIG. 2 depicts a detail view of the cage of FIG. 1.

FIG. 3 depicts a metal mesh of a cage consistent with at least one embodiment of the present disclosure.

FIG. 4A depicts a perspective view of a cage consistent with at least one embodiment of the present disclosure in an open position.

FIG. 4B depicts a perspective view of the cage of FIG. 4A in a closed position.

FIG. 4C depicts a top view of the cage of FIG. 4B.

FIG. 5A depicts a partial cross section view of a cage consistent with embodiments of the present disclosure in an open position.

FIG. 5B depicts a partial cross section view of the cage of FIG. 5A in a closed position.

FIG. 6 depicts a perspective view of a cage consistent with at least one embodiment of the present disclosure.

FIG. 7 depicts a perspective view of a cage consistent with at least one embodiment of the present disclosure.

FIGS. 8A, 8B depict the forming of a metal mesh of a cage consistent with at least one embodiment of the present disclosure.

FIG. 9A depicts a perspective view of a latch consistent with at least one embodiment of the present disclosure.

FIG. 9B depicts a perspective view of a latch consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

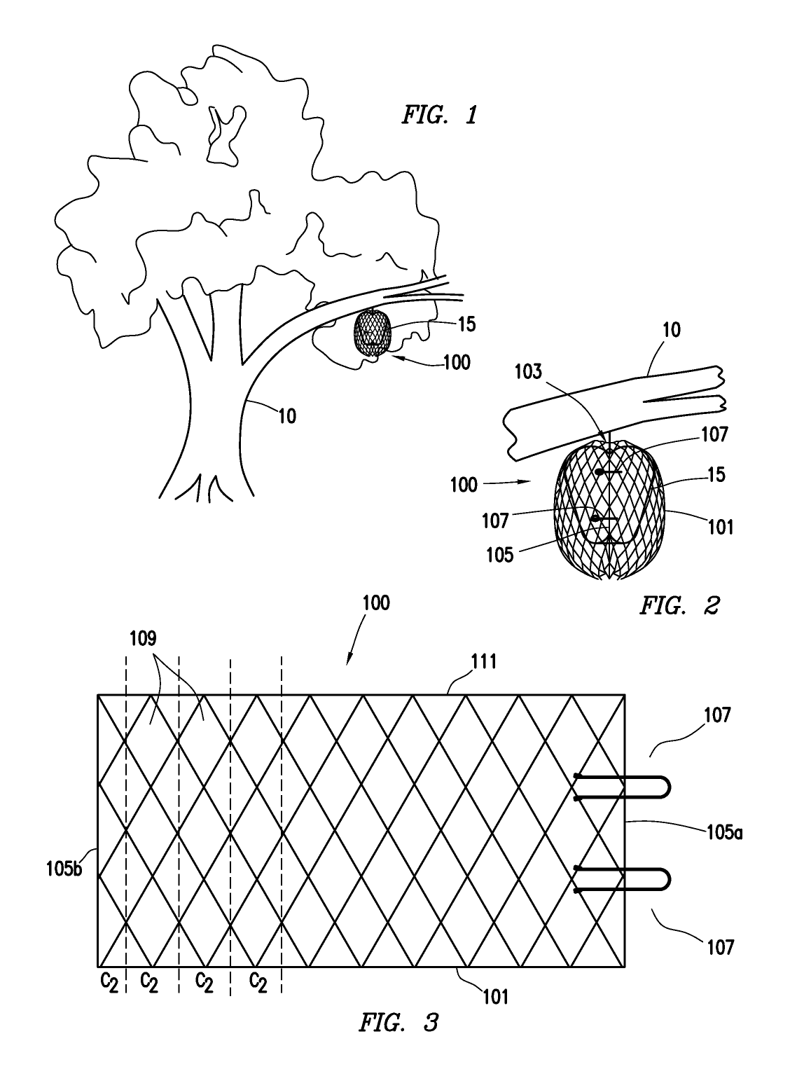

As depicted in FIG. 1, plant 10 may include one or more pieces of fruit or vegetable, referred to herein as produce 15. Produce 15 may be, for example and without limitation, a fruit or vegetable. As depicted in FIG. 1, plant 10 is a tree producing fruit such as one or more apples. However, one having ordinary skill in the art with the benefit of this disclosure will understand that plant 10 may be any fruit or vegetable-bearing plant, including, for example and without limitation, a tree, shrub, bush, vine, or other plant. Produce 15 likewise may be any fruit or vegetable and may include, for example and without limitation, apples, pears, tomatoes, strawberries, figs, pomegranates, mangos, oranges, peaches, melons, dates, lemons, limes, grapes, or other fruits or vegetables.

Positioned on each piece of produce 15 is cage 100. Each cage 100 may be positionable about an individual piece of produce 15, although one having ordinary skill in the art with the benefit of this disclosure will understand that one or more pieces of produce 15 may be positionable within a single cage 100. For example, where pieces of produce are small or include multiple parts such as grapes, one or more pieces of produce 15 may be positionable within a single cage 100. In some embodiments, cage 100 may be placed about piece of produce 15 before it has ripened or matured while it is still attached to plant 10. In some embodiments, cage 100 may remain in place about piece of produce 15 until piece of produce 15 is picked.

In some embodiments, as depicted in FIG. 2, cage 100 may be generally spherical in shape. However, in some embodiments, cage 100 may be formed in other shapes for accommodating different pieces of produce 15. The size of cage 100 may be selected to generally correspond with the size of the piece of produce 15 with which it is to be used such that the piece of produce 15 may be positioned therein. In some embodiments, cage 100 may include opening 103 at the top to, for example and without limitation, allow piece of produce 15 to couple to plant 10 by its stem. In some embodiments, opening 103 may be sized large enough that the stem of produce 15 may pass therethrough while being small enough to resist any pests such as birds, rodents, or other small animals from gaining entry to cage 100 through opening 103.

In some embodiments, cage 100 may be configured such that light, water, and air may reach piece of produce 15 positioned therewithin while resisting any pests such as birds, rodents, or other small animals from gaining entry. In some embodiments, cage 100 may be formed from metal mesh 101. Metal mesh 101 may be formed from a material of sufficient gauge or thickness to retain the selected shape. In some embodiments, metal mesh 101 may be formed from a material of sufficient gauge or thickness and strength to resist the attempts of any anticipated pests to open or tear apart cage 100. In some embodiments, for example and without limitation, metal mesh 101 may be formed from steel, aluminum, or other metal.

In some embodiments, as depicted in FIG. 3, cage 100 may be formed from a single piece of metal mesh 101. In some embodiments, metal mesh 101 may be generally rectangular in shape, although one having ordinary skill in the art with the benefit of this disclosure will understand that other shapes of metal mesh 101 may be utilized without deviating from the scope of this disclosure.

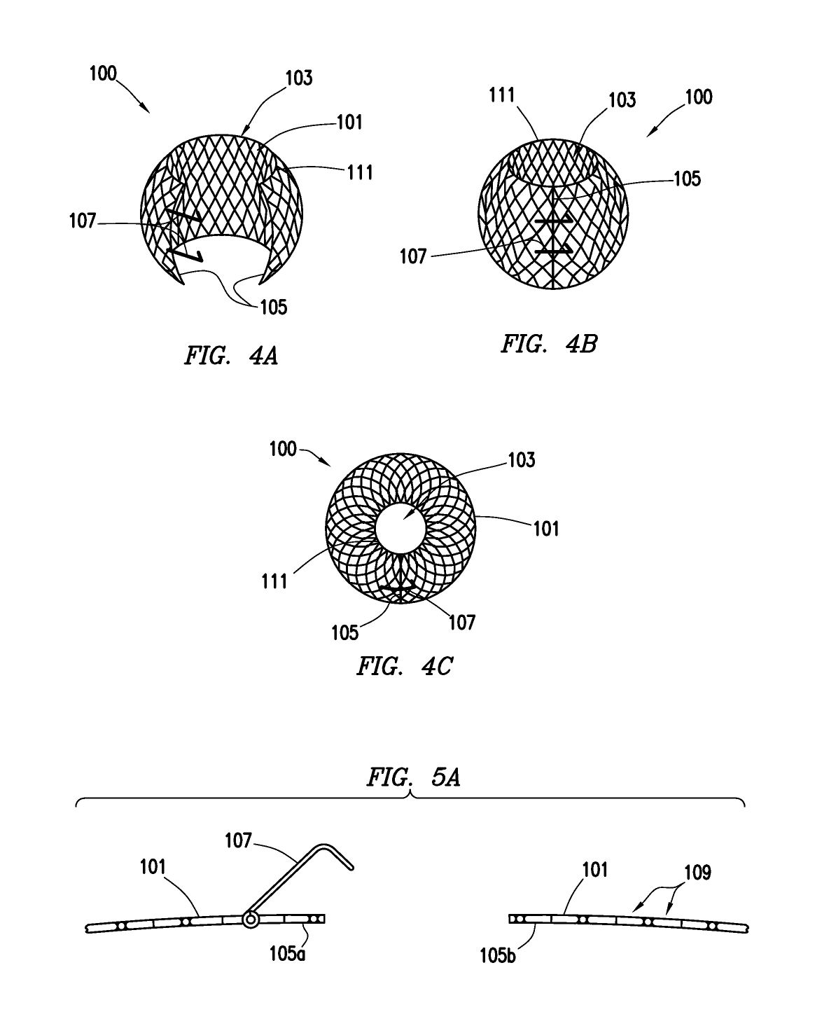

In some embodiments, as depicted in FIGS. 4A-C, metal mesh 101 may be formed into a generally spherical shape. Metal mesh 101 may be flexible enough to be opened as depicted in FIG. 4A to, for example and without limitation, position cage 100 about the piece of produce as discussed herein above. Once positioned about the piece of produce, metal mesh 101 may be pressed closed such that side edges 105 of metal mesh 101 meet or overlap. In some embodiments, one or more latches 107 may be coupled between the side edges 105 of metal mesh 101 to close cage 100 as depicted in FIG. 4B, and retain cage 100 to the piece of produce. In some embodiments, as depicted in FIG. 4C, opening 103 may be formed by forming metal mesh 101 such that the top edge 111 does not overlap when cage 100 is closed.

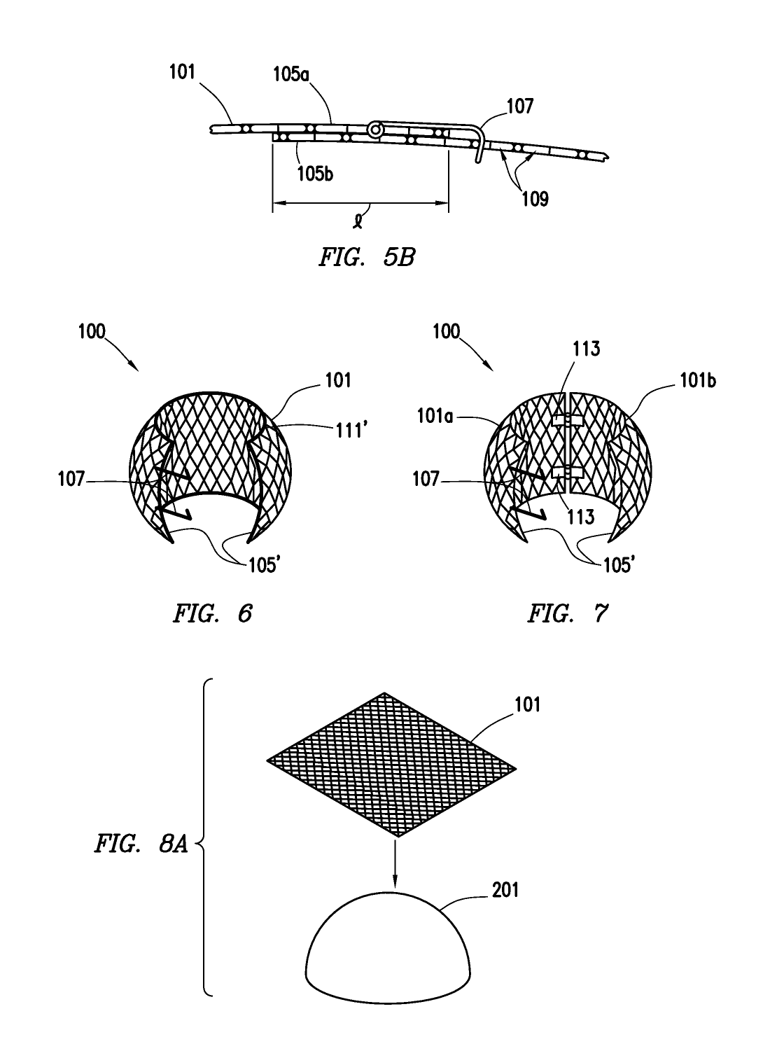

In some embodiments, latches 107 may be one or more hooks. In some embodiments, as depicted in FIGS. 5A, 5B, latches 107 may be formed from wire pivotably coupled to a first side edge 105a of metal mesh 101, and may hook onto second side edge 105b of metal mesh 101. In some embodiments, latches 107 may hook into one or more of holes 109, as understood in the art, of metal mesh 101. In some embodiments, the size of cage 100 may be determined at least in part based on the amount of overlap l between side edges 105a, b of metal mesh 101.

In some embodiments, metal mesh 101 may include one or more indicators of the size of cage 100 at certain predetermined overlaps l. For example, as depicted in FIG. 3, in some embodiments, metal mesh 101 may include one or more visual indicators such as color areas c₁-c₄ corresponding to aligned holes 109. In some embodiments, each color area c₁-c₄ may be colored a different color to, for example and without limitation, allow a user to select a size of cage 100 by inserting latches 107 into the holes 109 of a certain color area c₁-c₄ which corresponds with the desired size of cage 100.

In some embodiments, metal mesh 101 may include a coating. In some embodiments, the coating may be paint, or a plastic or rubber coating. In some embodiments, metal mesh 101 may be coated by spraying or by being dipped. The coating may be selected such that holes 109 remain open.

In some embodiments, one or more edges 105, 111 of metal mesh 101 may be crimped together to form or retain the shape of cage 100. In some embodiments, as depicted in FIG. 6, one or more edges 105′, 111′ of metal mesh 101 may be crimped or soldered together or to another piece to retain the shape of cage 100. In some embodiments, a closure mechanism 109′ may couple between crimped side edges 105′. Closure mechanism 109′ may be any suitable latch mechanism including, for example and without limitation, a hook and eye or other mechanism.

In some embodiments, as depicted in FIG. 7, cage 100 may be formed from two or more metal mesh pieces 101a, 101b. In some embodiments, each metal mesh piece 101a, 101b may be coupled to an adjacent piece by one or more hinges 113. In such an embodiment, cage 100 may be positioned about the piece of produce as previously discussed by opening cage 100 by hinging apart metal mesh pieces 101a, 101b and then closing them over the piece of produce. Although depicted as barrel hinges, one having ordinary skill in the art with the benefit of this disclosure will understand that metal mesh pieces 101a, 101b may be joined by any suitable mechanism for pivotably coupling them, including, for example and without limitation, any hinge, wire, or other connector. Although depicted as having two hinges 113, one having ordinary skill in the art with the benefit of this disclosure will understand that any number of hinges 113 may be utilized.

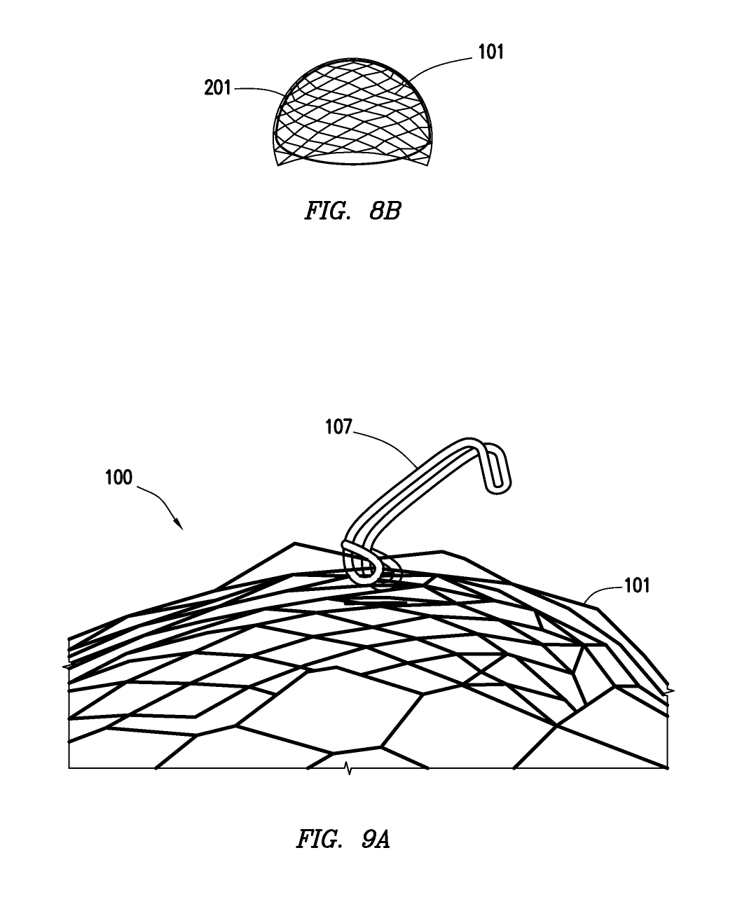

In some embodiments, as depicted in FIGS. 8A, 8B, to form metal mesh 101 into the desired shape as discussed herein above, metal mesh 101, while still flat, may be positioned over mold 201. Mold 201 may have a shape corresponding to the desired shape of metal mesh 101. One having ordinary skill in the art with the benefit of this disclosure will understand that in some embodiments, mold 201 may partially form metal mesh 101 into the desired shape, with additional forming done by hand or by additional molds (not shown) without deviating from the scope of this disclosure. Once formed, additional elements including, for example and without limitation, latches or crimp or soldered connections as discussed herein above may be added to metal mesh 101.

Although previously depicted as having two latches 107, one having ordinary skill in the art with the benefit of this disclosure will understand that any number of latches 107 may be utilized without deviating from the scope of this disclosure. For example, in some embodiments, cage 100 may include a single latch 107.

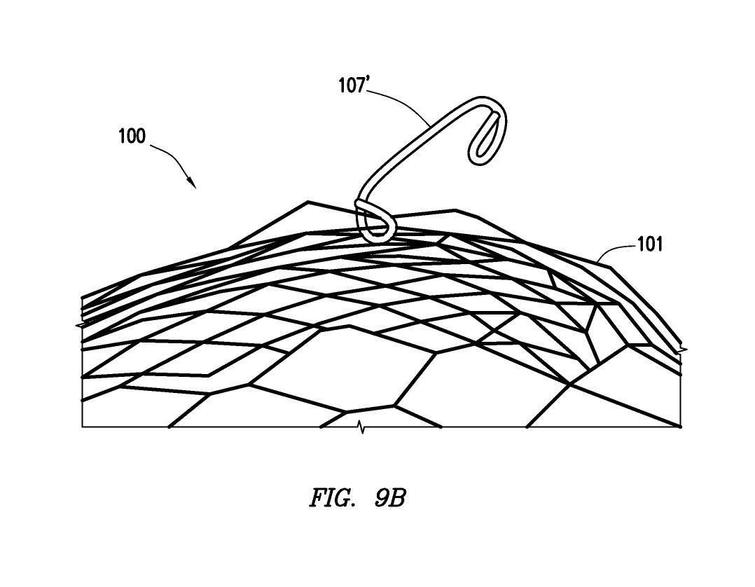

In some embodiments as depicted in FIG. 9A, latch 107 may be formed from a single piece of wire, which may be bent in half and bent at an angle to form the hook of latch 107. Each end of the wire of latch 107 may be wrapped around metal mesh 101 such that latch 107 is secured to metal mesh 101 while being able to pivot. In some embodiments, as depicted in FIG. 9B, latch 107′ may be formed from a single wire, with one end wrapped around metal mesh 101. The other end may be bent into the hook of latch 107′. In some embodiments, the hook end of latch 107′ may be bent and doubled to, for example and without limitation, increase the strength of latch 107′, engage metal mesh 105, or move the sharp end of the wire of latch 107′ away from the end of latch 107′.

Although described herein as utilizing a metal mesh, one having ordinary skill in the art with the benefit of this disclosure will understand that any metal mesh, including wire mesh and expanded or expandable metal mesh, may be utilized without deviating from the scope of this disclosure, and may be formed by weaving, knitting, welding, expanding, etching, or electroforming.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A cage for a piece of produce comprising:
a metal mesh, the metal mesh having a shape adapted to fit around the piece of produce, the metal mesh having a first side edge and a second side edge, the metal mesh having a top edge; and
a latch coupled to the first side edge, the latch selectively coupleable to the second side edge.

2. The cage of claim 1, wherein the shape is substantially spheroidal.

3. The cage of claim 1, wherein the latch comprises a hook pivotably coupled to the metal mesh at the first side edge and, when engaged to the second side edge, extends into one or more holes formed in the metal mesh at the second side edge.

4. The cage of claim 3, wherein the hook is formed from a piece of wire.

5. The cage of claim 3, wherein the first side edge and second side edge of the metal mesh overlap, and the length of overlap is determined by which of the holes the hook extends into.

6. The cage of claim 4, wherein the metal mesh includes a first hole having a first color and the second hole having a second color, each hole corresponding to a different length of overlap.

7. The cage of claim 1, wherein the metal mesh is formed from two or more metal mesh pieces.

8. The cage of claim 7, wherein the metal mesh pieces are coupled to one another by a hinge.

9. The cage of claim 1, wherein the metal mesh includes a plastic or rubber coating.

10. The cage of claim 1, wherein the top edge forms an opening into the cage through which a stem of the piece of produce may extend.

11. The cage of claim 10, wherein the opening is sized small enough that a pest is restricted from entering the cage.

12. The cage of claim 1, wherein one or more of the top edge or side edges are crimped.

13. The cage of claim 1, wherein one or more of the top edge or side edges are soldered.

14. The cage of claim 1, wherein the metal mesh is shaped by pressing a flat piece of metal mesh against a mold.

15. The cage of claim 1, wherein the metal mesh is formed in a shape generally corresponding to the size and shape of the piece of produce

16. A method comprising:
providing a cage for a piece of produce, the cage including:
a metal mesh, the metal mesh having a shape adapted to fit around the piece of produce, the metal mesh having a first side edge and a second side edge, the metal mesh having a top edge; and
a latch coupled to the first side edge, the latch selectively coupleable to the second side edge;
positioning the metal mesh about the piece of produce;
pressing the first and second side edges together such that they meet or overlap; and
engaging the latch with the second side edge.
